(19) United States
(12) Patent Application Publication
(10) Pub. No.: US 2009/0199284 A1
(43) Pub. Date: Aug. 6, 2009

(54) METHODS FOR SETTING AND CHANGING THE USER CREDENTIAL IN INFORMATION CARDS

(75) Inventors: Daniel S. Sanders, Orem, UT (US); Andrew A. Hodgkinson, Pleasant Grove, UT (US); Carolyn Ford, Lehi, UT (US)

Correspondence Address: MARGER JOHNSON & MCCOLLOM, P.C. - NOVELL, 210 SW MORRISON STREET, SUITE 400, PORTLAND, OR, 97204, US

(73) Assignee: NOVELL, INC., Provo, UT (US)

(21) Appl. No.: 12/026,775

(22) Filed: Feb. 6, 2008

(51) Int. Cl. G06F 21/00

(52) U.S. Cl. 726/9

(57) ABSTRACT

An identity provider issues information cards in which the credential type and/or the credential data is not specified at the time of issuance. A card selector installs the information cards and either prompts a user for the credential at the time of installation or afterwards. The card selector updates the credential type, the credential data, and/or authentication materials associated with an information card after the information card has been installed, and informs the identity provider about the credential type, credential data, and authentication materials before the information card is used.

### FIELD OF THE INVENTION

This invention pertains to performing on-line business transactions using information cards, and more particularly to setting and changing the user credential in information cards.

### BACKGROUND OF THE INVENTION

When a user interacts with sites on the Internet (hereafter referred to as “service providers” or “relying parties”), the service provider often expects to know something about the user that is requesting the services of the provider. The typical approach for a service provider is to require the user to log into or authenticate to the service provider's computer system. But this approach, while satisfactory for the service provider, is less than ideal for the user. First, the user must remember a username and password for each service provider who expects such information. Given that different computer systems impose different requirements, and the possibility that another user might have chosen the same username, the user might be unable to use the same username/password combination on each such computer system. (There is also the related problem that if the user uses the same username/password combination on multiple computer systems, someone who hacks one such computer system would be able to access other such computer systems.) It is estimated that an average user has over 100 accounts on the Internet. For users, this is becoming an increasingly frustrating problem to deal with. Passwords and account names are too hard to remember. Second, the user has no control over how the service provider uses the information it stores. If the service provider uses the stored information in a way the user does not want, the user has relatively little ability to prevent such abuse, and essentially no recourse after the fact.

In the past year or two, the networking industry has developed the concept of information cards to tackle these problems. Information cards are a very familiar metaphor for users and the idea is gaining rapid momentum. Information cards allow users to manage their identity information and control how it is released. This gives users greater convenience in organizing their multiple personae, their preferences, and their relationships with vendors and identity providers. Interactions with on-line vendors are greatly simplified.

There are currently two kinds of information cards: 1) personal cards (or self-issued cards), and 2) managed cards—or cards that are issued by an identity provider. A personal card contains self-asserted identity information—the person issues the card and is the authority for the identity information it contains. The managed card is issued by an identity provider. The identity provider provides the identity information and asserts its validity.

When a user wants to release identity information to a relying party (for example, a web site that the user is interacting with), a tool known as a card selector assists the user in selecting an appropriate information card. When a managed card is selected, the card selector communicates with the identity provider to obtain a security token that contains the needed information. This interaction between the card selector and the identity provider is usually secure. The identity provider typically requests the user to authenticate himself or herself (for example, using a username/password, X.509 certificate, etc.) before it will return a security token. According to conventional implementations, the type of credential that is needed is specified in the information card.

Currently, the process of issuing and installing a managed card can be awkward when certain types of credentials are used. The steps involved are not intuitive to the average user, and so users are easily confused by the steps they must go through to install the managed card.

The most common type of credential for a managed information card is username/password. If the information card specifies that username/password is required to authenticate to the identity provider, a card selector will generally prompt the user to enter a username and password before it will request a security token. Although the number of passwords a user must remember is reduced (to a few identity providers as opposed to hundreds of web sites), it is still very annoying for a user to have to enter a user name and password after having selected a managed information card for use at a web site.

To solve this problem, other authentication methods have been developed that do not require any user interaction beyond the selecting of a card. Two such methods are: 1) an X.509 certificate which is associated with the managed card, and 2) a personal card that is associated with the managed card. When a managed card containing one of these types of credentials is selected, the authentication material for the credential type is sent to the identity provider without the user having to enter anything. The assumption, of course, is that the identity provider will be able to use the authentication material to find and authenticate the user and thereby return the user's identity information. Generally, using authentication materials other than username/password will require the identity provider to associate the new kinds of authentication material with the user's identity information. For example, if the credential type is a personal card, the authentication material can consist of a PPID (private personal identifier) and a public key. In order for an identity provider to be able to use a PPID+Public Key as authentication material, it must somehow associate the PPID+Public Key with a user account.

Although managed cards with a credential type of personal card are very convenient to use, they are awkward to issue and install. In order for an identity provider to issue an information card that uses such a credential, the identity provider should have the needed credential data to embed in a card it issues. For a personal card credential type this is the PPID (private personal identifier) of the personal card calculated with respect to the identity provider. In addition, the identity provider should have the authentication material that will be sent for this type of credential, which is the PPID and a Public Key. The PPID+Public Key is needed so the identity provider can create an appropriate association between the PPID+Public Key and the user's account. According to conventional systems, this information is needed before the managed card can be issued. The only way to get a personal card's PPID and Public Key is to invoke the card selector. If an identity provider is trying to automate the process of issuing a managed card, it is suddenly faced with injecting a step that requires dialog with a human. This step can appear to be very out-of-place from the user's perspective. Even in situations where the issuing of a card is not automated and an attempt is made to make it clear to a user what he is expected to do to select a personal card, the user can be easily confused about what he is supposed to do while using the card selector. It is not obvious once inside the card selector that the user is being asked to select a personal card to be used as a credential for a yet-to-be-issued managed card. Furthermore, after selecting a personal card, and after being issued the managed card, the user will find himself or herself inside the card selector once again to install the managed card. The two trips into the card selector have proven to be very difficult to explain to users who do not really understand all of the nuances of using a personal card as a credential for their managed card.

A need remains for a way to addresses these and other problems associated with the prior art.

### SUMMARY OF THE INVENTION

Embodiments of the invention have to do with how credential information stored in managed information cards is obtained and updated. This invention provides a method for allowing credentials to be selected for a managed card after the managed card is issued and installed. Further, the invention provides a secure mechanism for allowing the appropriate authentication materials to be communicated to the appropriate identity provider so the identity provider can associate the authentication materials with the right user account.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a sequence of communications between a client, a relying party, and an identity provider.

FIG. 2 shows details of the computer system of FIG. 1.

FIG. 3 shows an information card including a credential.

FIG. 4 shows a sequence of communications between a computer system and an identity provider to obtain and install a managed card with a personal card as the credential according to conventional methods.

FIG. 5 shows a sequence of communications between a computer system and an identity provider to obtain and install a managed card with a personal card as the credential according to an embodiment of the invention.

FIG. 6 shows a sequence of communications between a client and an identity provider to provide the identity provider with authentication materials according to some embodiments of the present invention.

FIG. 7 shows a flowchart of a procedure to obtain a managed card according to an embodiment of the invention.

FIGS. 8A and 8B show a flowchart of a procedure to update a managed card according to an embodiment of the invention.

### DETAILED DESCRIPTION OF THE PREFERRED EMBODIMENT

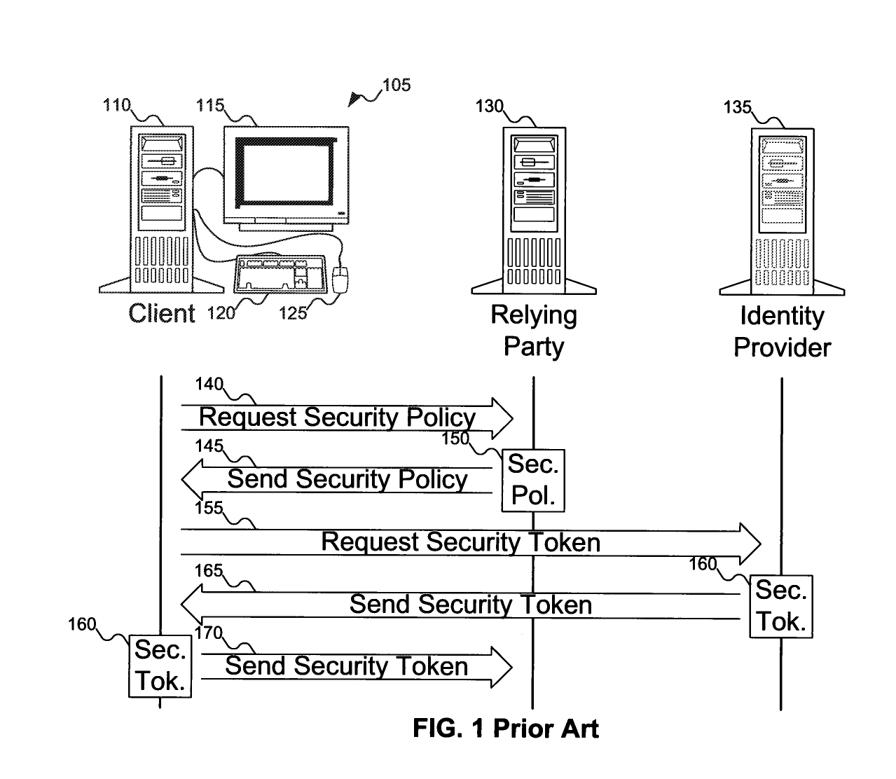

Before explaining the invention, it is important to understand the context of the invention. FIG. 1 shows a sequence of communications between a client, a relying party, and an identity provider. For simplicity, each party (the client, the relying party, and the identity provider) may be referred to by their machines. Actions attributed to each party are taken by that party's machine, except where the context indicates the actions are taken by the actual party.

In FIG. 1, computer system 105, the client, is shown as including computer 110, monitor 115, keyboard 120, and mouse 125. A person skilled in the art will recognize that other components can be included with computer system 105: for example, other input/output devices, such as a printer. In addition, FIG. 1 does not show some of the conventional internal components of computer system 105; for example, a central processing unit, memory, storage, etc. Although not shown in FIG. 1, a person skilled in the art will recognize that computer system 105 can interact with other computer systems, such as relying party 130 and identity provider 135, either directly or over a network (not shown) of any type. Finally, although FIG. 1 shows computer system 105 as a conventional desktop computer, a person skilled in the art will recognize that computer system 105 can be any type of machine or computing device capable of providing the services attributed herein to computer system 105, including, for example, a laptop computer, a personal digital assistant (PDA), or a cellular telephone.

Relying party 130 is a machine managed by a party that relies in some way on the identity of the user of computer system 105. The operator of relying party 130 can be any type of relying party. For example, the operator of relying party 130 can be a merchant running a business on a website. Alternatively, the operator of relying party 130 can be an entity that offers assistance on some matter to registered parties. Relying party 130 is so named because it relies on establishing some identifying information about the user.

Identity provider 135, on the other hand, is managed by a party responsible for providing identity information (or other such information) about the user for consumption by the relying party 130. Depending on the type of information identity provider 135 stores for a user, a single user might store identifying information with a number of different identity providers 135, any of which might be able to satisfy the request of the relying party 130. For example, identity provider 135 might be a governmental agency, responsible for storing information generated by the government, such as a driver's license number or a social security number. Alternatively, identity provider 135 might be a third party that is in the business of managing identity information on behalf of users.

The conventional methodology of releasing identity information can be found in a number of sources. One such source is Microsoft Corporation, which has published a document entitled Introducing Windows CardSpace, which can be found on the World Wide Web at http://msdn2.microsoft.com/en-us/library/aa480189.aspx and is hereby incorporated by reference. To summarize the operation of Windows CardSpace, when a user wants to access some data from relying party 130, computer system 105 requests the security policy of relying party 130, as shown in communication 140, which is returned in communication 145 as security policy 150. Security policy 150 is a summary of the information relying party 130 needs, how the information should be formatted, and so on.

Once computer system 105 has security policy 150, computer system 105 can identify which information cards will satisfy security policy 150. Different security policies might result in different information cards being usable. For example, if relying party 130 simply needs a username and password combination, the information cards that will satisfy this security policy will be different from the information cards that satisfy a security policy requesting the user's full name, mailing address, and social security number. The user can then select an information card that satisfies security policy 150.

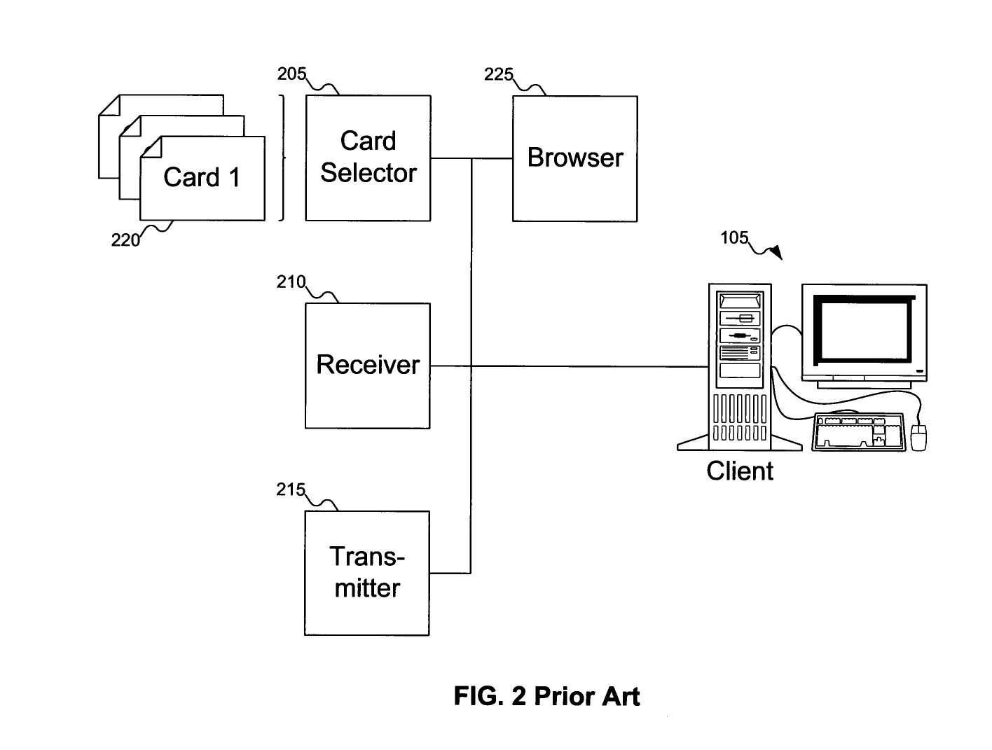

A card selector (described below with respect to FIG. 2) on computer system 105 may be used by the user to select the information card. The card selector may present the user with a list or graphical display of all available information cards and information cards that satisfy the security policy may be highlighted in some way to distinguish them from the remaining cards. Alternatively, the card selector may display only the information cards that will satisfy the security policy. The card selector may provide a means for the user to select the desired information card by, for instance, a mouse click or a touch on a touch screen.

Once the user has selected an acceptable information card, computer system 105 uses the selected information card to transmit a request for a security token from identity provider 135, as shown in communication 155. This request can identify the data to be included in the security token, the credential that identifies the user, and other data the identity provider needs to generate the security token. Identity provider 135 returns security token 160, as shown in communication 165. Security token 160 includes a number of claims, or pieces of information, that include the data the user wants to release to the relying party. Security token 160 is usually encrypted in some manner, and perhaps signed and/or time-stamped by identity provider 135, so that relying party 130 can be certain that the security token originated with identity provider 135 (as opposed to being spoofed by someone intent on defrauding relying party 130). Computer system 105 then forwards security token 160 to relying party 130, as shown in communication 170.

In addition, the selected information card can be a self-issued information card (also called a personal card): that is, an information card issued not by an identity provider, but by computer system 105 itself. In that case, identity provider 135 effectively becomes part of computer system 105.

In this model, a person skilled in the art will recognize that because all information flows through computer system 105, the user has a measure of control over the release of the user's identity information. Relying party 130 only receives the information the user wants relying party 130 to have, and does not store that information on behalf of the user (although it would be possible for relying party 130 to store the information in security token 160: there is no effective way to prevent such an act).

It should be apparent to a person skilled in the art that in order for this system to work, the user must have one or more information cards available for use, when required by a relying party. In the case of personal cards, the user can simply create the cards as desired. But in the case of managed cards, the user must interact with an identity provider to obtain each managed card.

FIG. 2 shows details of the computer system of FIG. 1. Referring to FIG. 2, computer system 105 includes card selector 205, receiver 210, transmitter 215, and browser 225. Card selector 205 is responsible for enabling a user to select an information card 220 that satisfies the security policy described above with respect to FIG. 1. Card selector 205 is also responsible for enabling a user to obtain managed cards from identity providers and to install the managed cards on computer system 105. Receiver 210 is responsible for receiving data transmitted to computer system 105, and transmitter 215 is responsible for transmitting information from computer system 105. The receiver 210 and the transmitter 215 may facilitate communications between, for example, computer system 105, relying party 130, and identity provider 135. The browser 225 allows the user to interact with web pages on a network: for example, web pages created by the identity provider 135. The user may use the browser 225 to obtain a managed card by, for example, visiting a web page created by the identity provider 135 and filling out a web-based form.

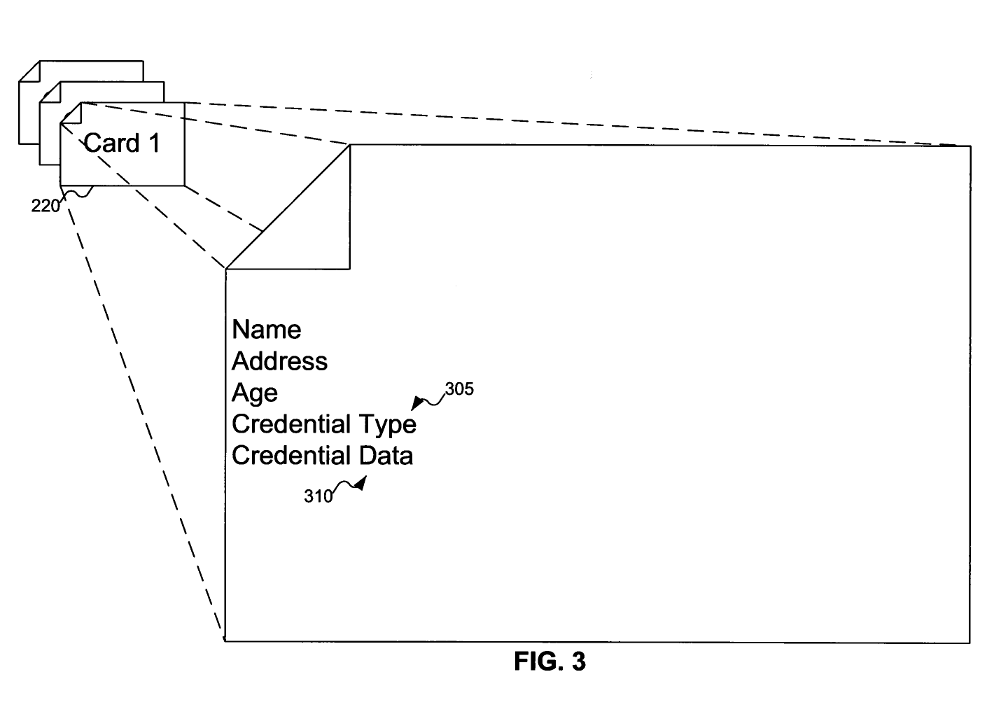

FIG. 3 shows an information card including a credential. In FIG. 3, an example of information card 220 is shown in greater detail. Information card 220 is shown as including the user's name, address, age, and credential. In particular, information card 220 includes a credential type 305 and credential data 310. Credential type 305 can be any credential type associated with information cards including, for example, username/password, X.509 certificate, and personal card. Credential data 310 includes information that is specific to the credential type 305 of information card 220. For example, if the credential type 305 of information card 220 is username/password, credential data 310 can include a username and a password. If the credential type 305 of information card 220 is personal card, credential data 310 can include a PPID of the personal card calculated with respect to the identity provider 135. A person skilled in the art will recognize that the credential type 305 can include other types of credentials and that the credential data 310 will include information that is specific to these other types of credentials. Although information card 220 is shown as including the user's name, address, age, and credential, information cards can include many other types of information, such as driver's license number, social security number, etc.

Where information card 220 is a managed information card (that is, managed by an identity provider 135), the information represented by information card 220 is not actually stored on the user's computer. This information is stored by the identity provider 135. Thus, the information displayed on information card 220 would not be the actual information stored by computer system 105, but rather an indicator of what information is included in information card 220.

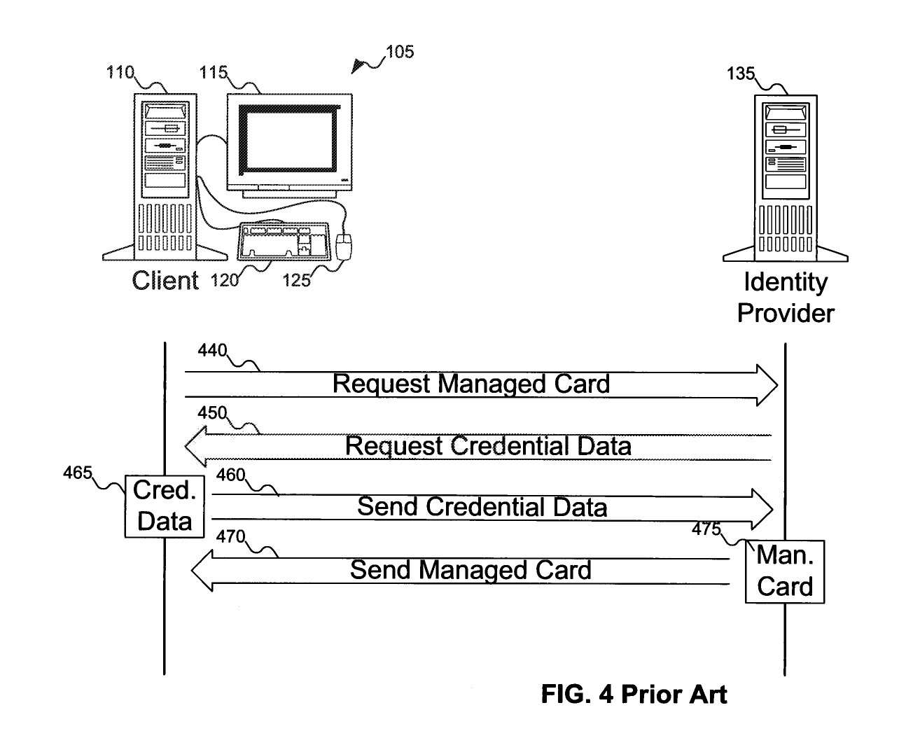

FIG. 4 shows a sequence of communications between a computer system and an identity provider to obtain and install a managed card with a personal card as the credential according to conventional methods. When a user wants to obtain a managed card, the computer system 105 sends a request 440 for a managed card to the identity provider 135. The request 440 can be sent by the browser 225 on computer system 105 and can be initiated by, for example, a user selecting a button on a form on a web page created by the identity provider 135. The request 440 specifies a credential type for the managed card and, depending on the credential type, credential data. The identity provider can prompt the user (via a web form) for this information when the user indicates the desire to obtain a managed card.

Once the identity provider 135 receives the request 440 for a managed card, the identity provider 135 examines the specified credential type, and if it is a personal card, it sends a message to the client machine (in one embodiment, an HTML form that is sent to the browser 225) that causes the card selector to be invoked in such a way as to ask the user to select a personal card. This step can be very confusing for a user because the user is being asked to select a personal card as a credential for a managed card that has yet to be issued. However, assuming the user is able to overcome this confusion and select the appropriate personal card, the computer system 105 sends a message 460 including the requested credential data 465, which is a PPID calculated with respect to the identity provider 135.

In the case of personal card and X.509 certificate credential types, the identity provider 135 can also request authentication materials in order to make the appropriate association between the authentication materials and a user account. Therefore, in the case of these credential types, the request 440 for credential data can also include a request for the authentication materials. In the case of the personal card credential type, the authentication materials are the PPID and the Public Key. Accordingly, the message 460 can include the authentication materials, when required. Upon receiving the authentication materials, the identity provider 135 associates the authentication materials with a specific user account.

When the identity provider 135 receives the message 460 including the credential data 465, the identity provider 135 creates the managed card 475. Once the managed card 475 is created, the identity provider 135 sends the managed card 475 in a message 470 to the computer system 105.

When the computer system 105 receives the message 470 including the managed card 465, the computer system 105 once again invokes the card selector 205 in order to install the managed card 465. So, the user, having already requested a managed card, selected the credential type, and selected/entered the credential data for the managed card, is now prompted by the card selector 205 to install the managed card. Again, this step can be confusing for a user that is unfamiliar with the intricacies involved in the process of establishing a managed card. Assuming the user is able to overcome this confusion and accepts the installation of the managed card 465, the managed card 465 is installed and is then available for use.

Thus, although managed cards with a credential type of personal card are convenient to use, the process of issuing and installing the managed cards is awkward for the user. In order for an identity provider to issue such a card, the identity provider must have the needed credential data to embed in a card it issues. The only way to get the credential data is to invoke the card selector to prompt the user for the information. This step can be confusing to the user. Furthermore, after selecting a personal card, and after being issued the managed card, the user will be in the card selector once again to install the card.

This confusion in the process for obtaining a managed card may result in a user not being able to obtain and use a managed card as desired. Further, a user may choose not to use managed cards at all because of the user's inability to understand the system for obtaining managed cards. Therefore, this problem in the conventional method for obtaining managed cards may limit the widespread adoption of the information card system.

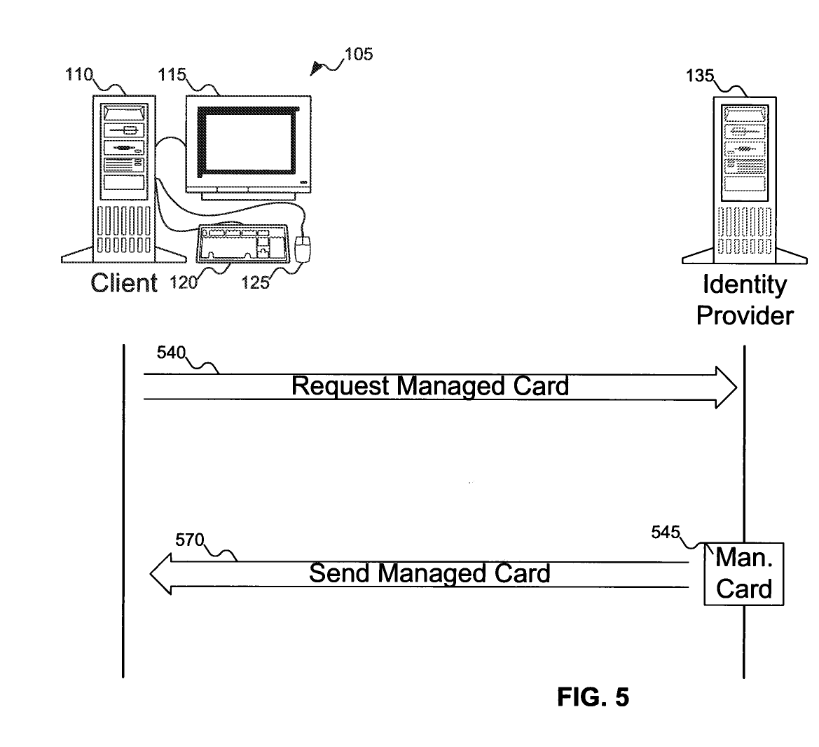

FIG. 5 shows a sequence of communications between a computer system and an identity provider to obtain and install a managed card with a personal card as the credential according to an embodiment of the invention. When a user wants to obtain a managed card, the computer system 105 sends a request 540 for a managed card to the identity provider 135. The request 540 can be sent by the browser 225 on computer system 105 and can be initiated by, for example, a user selecting a button on a form on a web page created by the identity provider 135. The request 540 does not need to specify a credential type or credential data for the managed card. The identity provider 135 can prompt the user (via a web form, for example) for this information when the user indicates the desire to obtain the managed card, but the user does not have to provide this information to obtain the managed card.

Once the identity provider 135 receives the request 540 for a managed card, the identity provider 135 generates the managed card 545 without any requests for additional information to the computer system 105. Depending upon the information included in the request 540 for the managed card 545, the identity provider 135 can issue a managed card 545 that includes a credential type but no credential data, or the identity provider 135 can issue a managed card 545 that does not even include a credential type. The identity provider then sends the managed card 545 to the computer system 105 in a message 570.

When the computer system 105 receives the message 570 including the managed card 545, the computer system 105 invokes the card selector 205 in order to install the managed card 545. The procedure for installing the managed card 545 will depend on whether the managed card 545 includes the credential type or not.

In the case in which the managed card 545 includes a credential type, the card selector 205 allows the user to supply the missing credential data at the time of installation of the managed card 545. For example, if the credential type is username/password, the card selector 205 might prompt the user for a username and password and optionally ask the user if it should remember the password. If the credential type is personal card, the card selector 205 might prompt the user to select a personal card. After selecting the personal card, the personal card's PPID with respect to the identity provider 135 would be calculated and stored with the managed card 545 in the card selector 205. A person of ordinary skill in the art would appreciate that in order to set the PPID, the card selector 205 uses information from the identity provider's SSL certificate, which might or might not be available at the time the managed card 545 is installed. Therefore, as an alternative to calculating the PPID at the time of installation, the card selector 205 can also have the option of calculating the PPID the first time the managed card 545 is used to request a security token from the identity provider 135. Thus, according to some embodiments of the invention, the managed card 545 can be installed by the card selector 205 even though the managed card 545 does not include credential data. The user can be prompted to supply the credential data at the time of installation of the managed card 545 and/or at the time of the first attempted use of the managed card 545.

In the case in which the managed card 545 is issued without a credential type, the card selector 205 gives the user the option of specifying both a credential type and the credential data at the time of installation. Also, the card selector 205 can allow the user to postpone providing the credential type and credential data until the first time the managed card is used to request a security token from the identity provider 135. Thus, the card selector 205 is capable of installing the managed card 545 even though the managed card 545 does not include a credential type and credential data.

The card selector 205 can keep track of the current state of the managed card 545 once the managed card 545 is installed. For instance, the card selector 205 can assign different current state values to the managed card 545, such as fully specified, partially specified, not specified, or changed, depending on whether the credential type and/or credential data of the managed card have been provided or changed.

As described above, according to some embodiments of the invention, the user only needs to interact with the card selector 205 to install the managed card, because the user can specify the credential type and credential data during or after installation of the managed card. This is a much more intuitive process for the user than the conventional method described above with respect to FIG. 4.

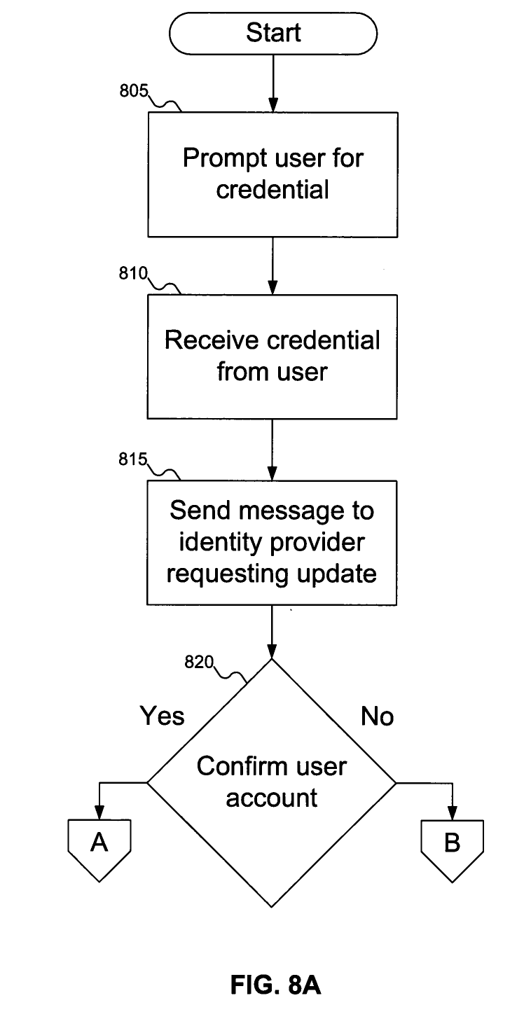

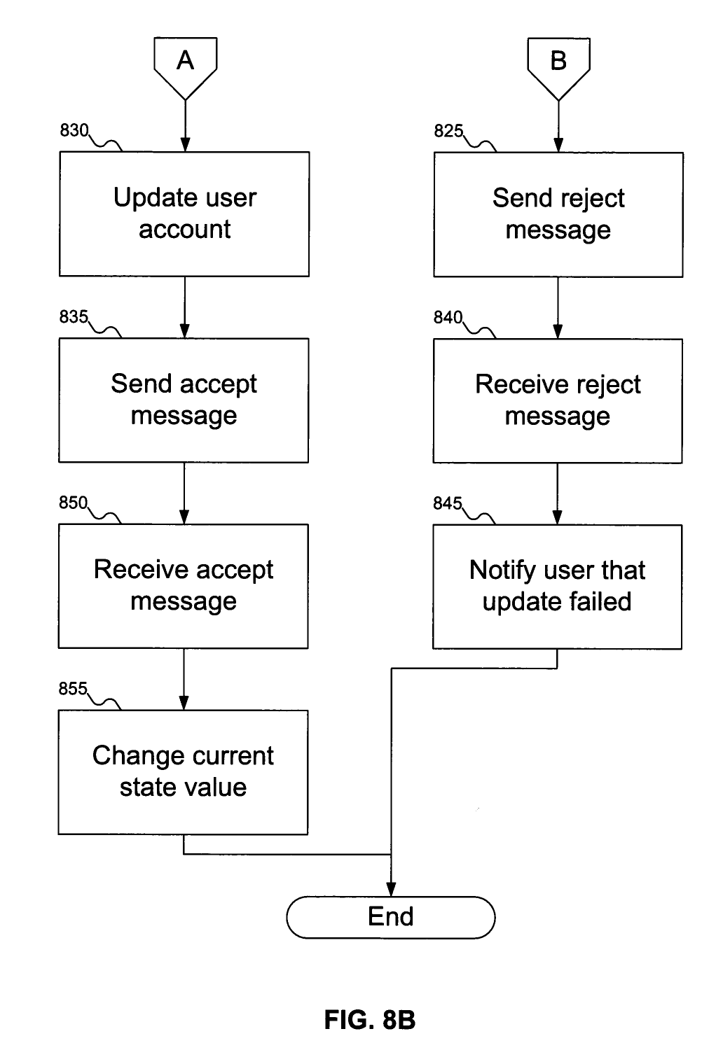

Although the method described above with respect to FIG. 5 is specific to the initial installation of a managed card, the method is also applicable to changing the credentials of a managed card. For example, once a managed card has been installed and the credential type and credential data has been specified, the card selector can be used to change the credential type and/or the credential data. This is described in further detail below with respect to FIG. 8.

A person of ordinary skill in the art will appreciate that when the credential type is personal card or X.509 certificate, the identity provider will require not only credential data, but also authentication materials, before the managed card can be used. Once the card selector has allowed a user to set or change a card's credential type and/or credential data, the card selector may need to generate authentication materials so that the managed card can be associated with the proper user account at the identity provider 135. Authentication materials can be, but are not necessarily, the same thing as the credential data. For example, the authentication materials for a personal card are PPID+Public Key, whereas the credential data is only PPID. In this case, the card selector can send the authentication materials associated with the credential to the identity provider before the card selector starts using the authentication materials to authenticate the user. This is because the identity provider might need to create an association between the authentication materials and the user's identity data (the user account). The process of communicating newly generated authentication materials to an identity provider can happen at any time, but is typically completed before the managed card can be used to obtain a security token. If the process of communicating newly generated authentication materials to an identity provider has not been completed and a user attempts to use the card to obtain a security token, the card selector can automatically perform the process before requesting the security token.

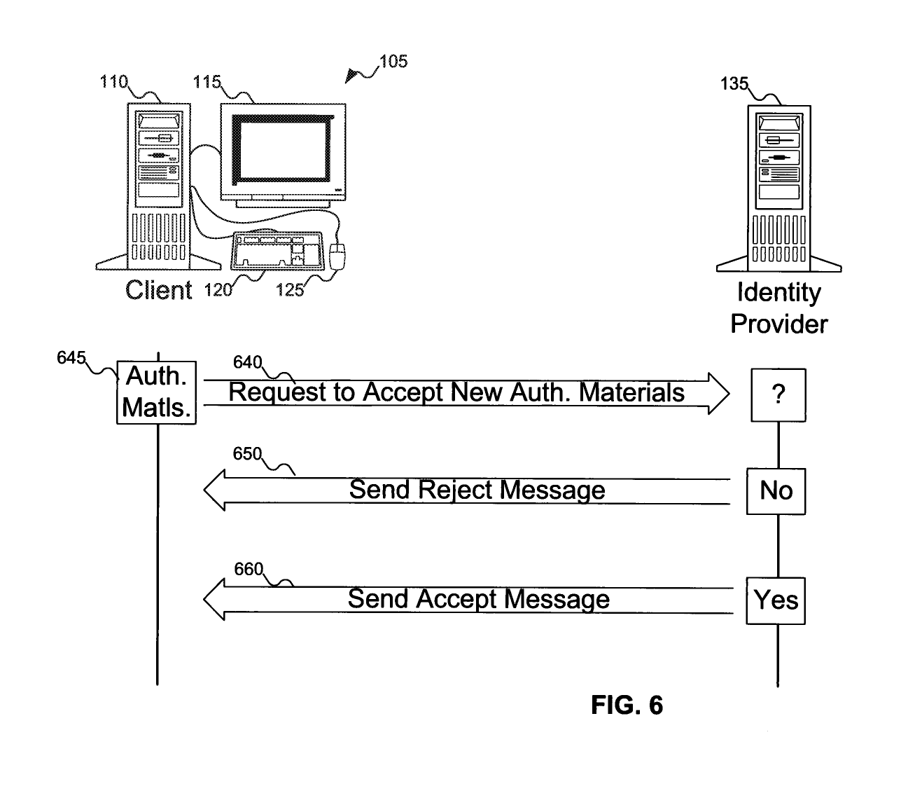

FIG. 6 shows a sequence of communications between a client and an identity provider to provide the identity provider with authentication materials according to some embodiments of the present invention. Initially, the card selector 205 generates a request 640 to the identity provider 135 requesting the identity provider 135 to accept new authentication materials 645. As described above with respect to FIG. 5, this request can be generated in response to the installation of a new managed card or at a later time. The request 640 contains authentication materials 645 that can be used to identify and authenticate the user identity. If a managed card has no current credential information (for example, none has been previously set), the card selector 205 will prompt the user to enter appropriate credentials that can be used to identity and authenticate the user to the identity provider 135 (most likely a username and password). If a managed card has current usable authentication materials, that authentication material will be sent. A person of ordinary skill in the art will appreciate that when a user changes a card's credential type or credential data, the old authentication material is typically retained until the new authentication material has been properly accepted by the identity provider 135. In this case, the request 640 contains the old authentication material as well as the new authentication material the card selector 205 wants the identity provider 135 to accept.

Upon receiving the request 640, the identity provider 135 looks up the user account using the old authentication material included in the request 640. If the identity provider 135 does not find a user account corresponding to the old authentication information, the identity provider 135 can return a “reject” message 650 with an indication that there is no such user account. The identity provider 135 has the option of rejecting the request 640 for any other reason as well. Upon receiving the reject message 650, the card selector 205 can notify the user of the rejection and/or prompt the user to try again.

If the identity provider 135 is able to find the appropriate user account and decides to accept the new authentication materials, the identity provider 135 creates an association between the new authentication materials and the user's identity information (user account). The identity provider 135 then returns an “accept” message 660 to the card selector 205 indicating that the new authentication materials have been accepted.

Upon receiving the message 660, the card selector 205 changes the current state of the managed card to indicate that the managed card now has a valid credential. The old credential, if any, can be destroyed.

A person of ordinary skill in the art will appreciate that the method described above with respect to FIG. 6 could also be used to allow a user to change a password on their identity provider 135 account from within a card selector 205. The new password is simply analogous to the new authentication material described above.

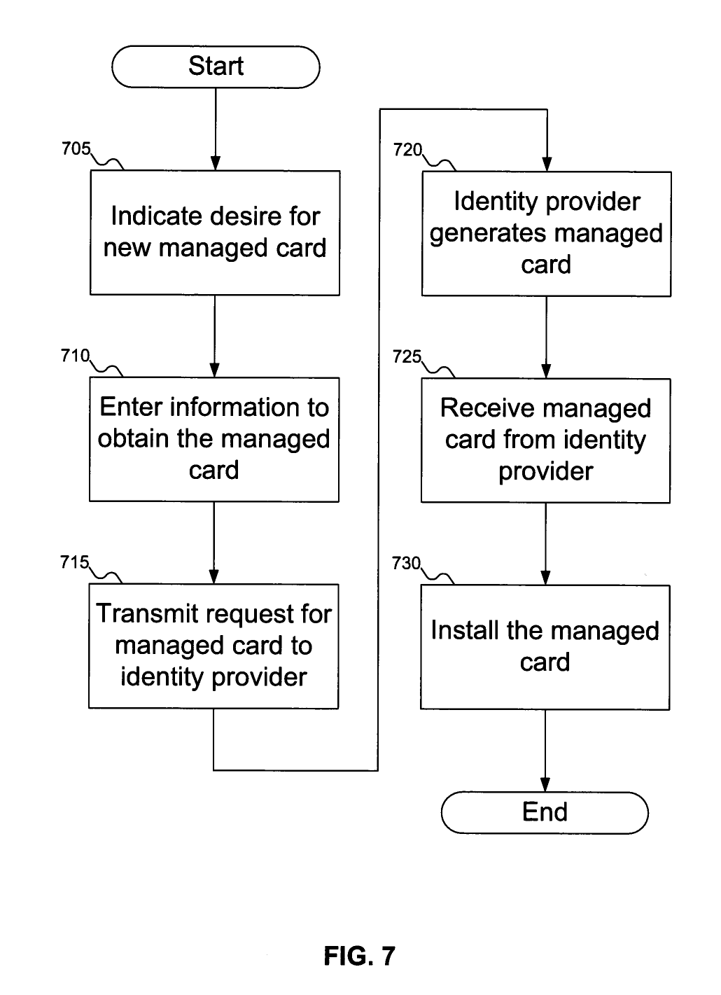

FIG. 7 shows a flowchart of a procedure to obtain a managed card according to an embodiment of the invention. Referring to FIG. 7, at block 705, a user indicates a desire to obtain a new managed card. The user may indicate this desire by, for example, using the browser 225 to visit a web page created by the identity provider 135 and clicking or touching a button in the browser 225. At block 710, the user enters information needed to obtain the managed card. As an example, identity provider 135 can prompt the user for this information by providing a web-based form to the browser 225. Along with other information, the web-based form can prompt the user to select a credential type and/or enter credential data. However, it is not necessary for the user to select a credential type and enter credential data in order to receive the managed card. A request for the managed card, along with the supporting information provided by the user, is transmitted to the identity provider 135 at step 715. As an example, transmitting the request to the identity provider 135 may include selecting a Submit or similar button in the browser 225 after the user fills in a web-based form provided by the identity provider 135.

At block 720, the identity provider 135 generates the managed card. The managed card can have a credential type and credential data if this information was provided by the user. Alternatively, the managed card may only have placeholders for the credential type and/or the credential data. In other words, the managed card may have both, one, or neither of a credential type and credential data, but the managed card has a position reserved (i.e., a placeholder) for such information when it is subsequently provided.

At block 725, the card selector 205 receives the managed card from the identity provider 135. Finally, at block 730, the card selector 205 installs the managed card 745. Installing the managed card 745 can include prompting the user about whether or not to install the managed card 745. The card selector 205 can also ask the user if the user would like to designate a credential type and/or credential data for the managed card 745 during installation. If the user chooses to enter a credential type and/or credential data at this time, the card selector 205 can initiate the method described below with respect to FIG. 8 to update the managed card 745. If the user does not choose to enter a credential type and/or credential data, and the managed card 745 does not already include the credential type and credential data, the managed card 745 will not be useable until such information is provided to the identity provider 135. Installing the card can also include associating a current state value to the managed card 745 indicating the current state of the credential for the managed card 745.

FIGS. 8A and 8B show a flowchart of a procedure to update a managed card according to an embodiment of the invention. Referring to FIGS. 8A and 8B, at block 805, a card selector 205 prompts a user for a credential type and/or credential data. The card selector 205 can be triggered to update the managed card by, for instance, a request by the user to use the managed card as part of the transaction described above with respect to FIG. 1 or as part of the installation procedure described above with respect to FIG. 7. At block 810, the user enters the credential type and/or credential data. The user may enter the credential type by, for example, selecting the credential type from a list provided in the card selector 205. The user may enter the credential data by filling in fields in the card selector 205 that are displayed depending on the credential type selected. For example, the user may select username/password as the credential type and the card selector 205 can provide a field for the user to enter the username. Alternatively, if the user selects personal card or X.509 certificate as the credential type, the card selector 205 can provide a list of available personal cards or X.509 certificates for the user to choose from. It should be noted that if the user selects personal card for the credential type, the card selector 205 will actually calculate the credential data (the PPID) once the desired personal card is selected, rather than the user entering the credential data. Therefore, when the user selects personal card for the credential type and selects a personal card, the selected personal card may be referred to as a credential source rather than credential data.

Depending on the credential type selected by the user, the identity provider 135 can require authentication materials to associate the credential with the appropriate user account. In this case, the card selector 205 can generate the authentication materials once the user has selected the credential type. For example, if the user selects personal card as the credential type and selects the desired personal card, the card selector 205 can generate both the credential data (the PPID) and the authentication materials (PPID+Public Key).

A person of ordinary skill in the art will recognize that if the credential is being changed from a previous credential, the card selector 205 will need to provide the old credential, and possibly old authentication materials, to the identity provider 135 along with the new credential, and possibly new authentication materials.

At block 815, the identity provider 135 receives a message from the card selector 205 requesting an update of the credential for the managed card. As described above, the message can include, among other possibilities, new authentication materials and old authentication materials. At block 820 the identity provider 135 determines if the message corresponds to a user account by, for instance, finding the user account using the old authentication materials (which should be sufficient for the identity provider to locate and authenticate the user account which is stored at the identity provider 135). If the identity provider 135 determines that the old authentication materials do not properly identify a user account, the identity provider 135 sends a reject message to the card selector 205 at block 825. If the identity provider 135 determines that the old authentication materials properly identify a user account, and the identity provider policy allows the user account's authentication materials to be updated, the identity provider 135 updates the user account with the new authentication materials at block 830 and then sends an accept message to the card selector at block 835.

In the case that the reject message is sent from the identity provider 135, the card selector 205 receives the reject message at block 840. At block 845, the card selector 205 can notify the user that the update has failed and/or prompt the user to try again.

In the case that the accept message is sent from the identity provider 135, the card selector 205 receives the accept message at block 850. Finally, at block 855, the card selector 205 can change the current state value of the managed card to reflect the fact that the credential of the managed card has been updated.

As described above, according to embodiments of the invention, a managed card can be issued from an identity provider and installed by a card selector without the credential type and/or credential data being specified. In this way, users are not confused by the process of obtaining the managed card. Further, a credential type and credential data of a managed card can be updated by a card selector after the managed card is installed. This could become necessary, for example, when a managed card has a credential type of personal card and the associated personal card is deleted. Finally, a card selector can be used to update authentication materials associated with a managed card. This could be used, for instance, to update a password associated with a specific user account on an identity provider from within a card selector.

Having described and illustrated the principles of the invention with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. An apparatus, comprising:
a machine;
a browser on the machine configured to receive a request for an information card from a user;
a transmitter configured to transmit the request to an identity provider;
a receiver configured to receive the information card from the identity provider, the information card including a placeholder for credential data; and
a card selector on the machine configured to install the information card into the card selector.

2. An apparatus according to claim 1, wherein the information card further includes a second placeholder for a credential type.

3. An apparatus according to claim 2, wherein the card selector is further configured to update the information card by providing at least one of the credential type, the credential data, and authentication materials to the identity provider.

4. An apparatus according to claim 1, wherein the card selector is further configured to prompt the user for at least one of a credential type, the credential data, and authentication materials when installing the information card into the card selector on the machine.

5. An apparatus according to claim 1, wherein the card selector is further configured to prompt the user for at least one of a credential type, the credential data, and authentication materials when the user selects the information card.

6. An apparatus according to claim 1, wherein the card selector is further configured to update the information card by providing at least one of the credential data and authentication materials to the identity provider.

7. An apparatus according to claim 6, wherein the card selector is further configured to associate a current state value with the information card.

8. A method for obtaining an information card from an identity provider, comprising:
receiving a request from a user for an information card;
transmitting the request for the information card to the identity provider;
receiving the information card from the identity provider, wherein the information card includes a placeholder for credential data; and
installing the information card into a card selector after receiving the information card.

9. A method according to claim 8, wherein the information card further includes a second placeholder for a credential type.

10. A method according to claim 9, further comprising prompting the user for at least one of the credential type, the credential data, and authentication materials when installing the information card.

11. A method according to claim 8, further comprising prompting the user for a credential type before transmitting the request.

12. A method according to claim 8, further comprising prompting the user for at least one of the credential data and authentication materials when installing the information card.

13. A method according to claim 11, further comprising prompting the user for at least one of a credential type, the credential data, and authentication materials after installing the information card.

14. A method according to claim 11, further comprising updating a current state value associated with the information card.

15. An article, comprising a storage medium, the storage medium having stored thereon instructions that, when executed by a machine, result in:
receiving a request from a user for an information card;
transmitting the request for an information card to an identity provider;
receiving the information card from the identity provider, wherein the information card includes a placeholder for credential data; and
installing the information card into a card selector after receiving the information card.

16. An article according to claim 15, wherein the information card further includes a second placeholder for a credential type.

17. An article according to claim 16, wherein:
the storage medium has stored thereon further instructions that, when executed by the machine, result in:
prompting the user for at least one of the credential type, the credential data, and authentication materials when installing the information card.

18. An article according to claim 15, wherein:
the storage medium has stored thereon further instructions that, when executed by the machine, result in:
prompting the user for a credential type before transmitting the request.

19. An article according to claim 18, wherein:
the storage medium has stored thereon further instructions that, when executed by the machine, result in:
prompting the user for at least one of the credential data and authentication materials when installing the information card.

20. An article according to claim 15, wherein:
the storage medium has stored thereon further instructions that, when executed by the machine, result in:
prompting the user for at least one of a credential type, credential data, and authentication materials after installing the information card.

21. An article according to claim 15, wherein:
the storage medium has stored thereon further instructions that, when executed by the machine, result in:
updating a current state value associated with the information card.

22. A method for updating an information card, comprising:
identifying the information card, the information card having associated old credential data;
obtaining new credential data for the information card from a user, wherein the new credential data is different from the old credential data;
transmitting an update request to an identity provider, the update request including the new credential data; and
receiving a response message from the identity provider.

23. A method according to claim 22, wherein the response message is a reject message indicating that the information card is not updated.

24. A method according to claim 22, wherein the response message is an accept message indicating that the information card is updated.

25. A method according to claim 24, further comprising changing a current state value of the information card responsive to the accept message.

26. A method according to claim 22, wherein obtaining the new credential data comprises:
prompting the user to select a credential type;
prompting the user to select a credential source; and
generating the new credential data responsive to the selection of the credential type and the credential source.

27. A method according to claim 26, wherein generating the new credential data comprises generating a Private Personal Identifier (PPID) when the credential source selected by the user is a personal card.

28. A method according to claim 22, wherein transmitting the update request comprises transmitting the update request including the old credential information.

29. A method according to claim 22, wherein transmitting the update request comprises transmitting the update request including new authentication materials and old authentication materials.

30. A method according to claim 29, wherein transmitting the update request further comprises transmitting the update request including a new password and an old password.
